(19) United States
(12) Patent Application Publication
(10) Pub. No.: US 2012/0044057 A1
(43) Pub. Date: Feb. 23, 2012

(54) PAIRING METHOD OF DEVICE USING MILIMETER WAVE BAND AND DEVICE FOR PERFORMING THE SAME

(75) Inventors: Tae Young KANG, Daejeon (KR); Seong Su PARK, Daejeon (KR); Sung Weon KANG, Daejeon (KR); Seok Bong HYUN, Daejeon (KR); Kyung Hwan PAKR, Daejeon (KR); Byong Gun CHOI, Daejeon (KR); Chang Hee HYOUNG, Daejeon (KR); Jung Hwan HWANG, Daejeon (KR); Sung Eun KIM, Seoul (KR)

(73) Assignee: Electronics and Telecommunications Research Institute, Daejeon (KR)

(21) Appl. No.: 12/969,953

(22) Filed: Dec. 16, 2010

(30) Foreign Application Priority Data
Aug. 17, 2010 (KR) 10-2010-0079378

(51) Int. Cl. H04Q 5/22

(52) U.S. Cl. 340/10.4

(57) ABSTRACT

The pairing method of first and second devices each having a communication function using a millimeter wave band, includes: determining, by the first device, whether or not the a security code of the second device has been registered; when the first device determines that the security code of the second device has been registered, transmitting, by the first device, an activation command instructing the second device to perform millimeter wave band communication, a device ID, and the security code of the second device to the second device through RFID communication; and when the first device receives a message indicating that the second device is ready for millimeter wave band communication from the second device, activating, by the first device, an element for performing communication using the millimeter wave band.

### CROSS-REFERENCE TO RELATED APPLICATIONS

This application claims the priority of Korean Patent Application No. 10-2010-0079378 filed on Aug. 17, 2010, in the Korean Intellectual Property Office, the disclosure of which is incorporated herein by reference.

### BACKGROUND OF THE INVENTION

1. Field of the Invention

The present invention relates to pairing of a wireless communication device and, more particularly, to a pairing method of a device using a millimeter wave band that can be applicable to a device using a millimeter wave band, and a device for performing the same.

2. Description of the Related Art

As a millimeter wave (57 to 66 GHz) band was allocated as an unlicensed or ISM (industrial, scientific and medical) band and used as a solution to the shortage of frequency resources worldwide, standardizations are being actively ongoing, such as ETSI/BRAN in Europe, IEEE 802 in North America, as well as ISO 21216, WiHD consortium, Ecma International, and the like, elsewhere.

A 60 GHz frequency band has advantages in that it has a higher data transfer rate than Bluetooth™ or UWB (Ultra-Wide Band) by using an ultra-wide band, has strong straightness to resist ambient interference, has high security, and allows for the re-use of a frequency. In addition, because the 60 GHz frequency band has a short wavelength, it allows for a reduction in size and weight of various elements, as such the 60 GHz frequency band can be easily applied for a mobile device.

However, the 60 GHz frequency band has shortcomings in that it has a short propagation distance due to absorption by oxygen molecules, an attenuation phenomenon in the case of rain and the necessity of securing a line of sight due to the characteristics of straightness, so currently, the 60 GHz frequency band is largely applied for high resolution AV streaming in devices having a proximity within a maximum 10 meters, a wireless docking station, a short range communication device (e.g., a short range sync & go.)

For communication between devices using the 60 GHz frequency band, it is first required to determine whether or not there is a device, available for communication, within a short distance (or nearby) such as Bluetooth™ or WLAN and then a pairing process is required to establish security.

However, when the pairing process is performed by using the 60 GHz band, it consumes a great deal of power as compared with a system that performs pairing by using a 2.4 GHz band, a usage time of a mobile device that uses a battery as a power source is reduced. In detail, when a certain communication device using the 60 GHz band receives a request for pairing from a user, the communication device first searches for adjacent devices, displays found devices, and performs a pairing with a particular device selected from among the displayed devices searched for by the user. In this case, the devices around the certain communication device must periodically wake up a 60 GHz band communication module in order to respond to the pairing request from the certain communication device, causing power consumption, resulting in a reduction of overall usage time of the devices using a battery as a power source.

### SUMMARY OF THE INVENTION

An aspect of the present invention provides a pairing method of a device using a millimeter wave band capable of minimizing power consumption of the device using a millimeter wave band and easily performing pairing.

An aspect of the present invention provides a device using a millimeter wave band performing the pairing method.

According to an aspect of the present invention, there is provided a pairing method of first and second devices each having a communication function using a millimeter wave band, including: determining, by the first device, whether or not the a security code of the second device has been registered; when the first device determines that the security code of the second device has been registered, transmitting, by the first device, an activation command instructing the second device to perform millimeter wave band communication, a device ID, and the security code of the second device to the second device through RFID communication; and when the first device receives a message indicating that the second device is ready for millimeter wave band communication from the second device, activating, by the first device, an element for performing communication using the millimeter wave band.

The method may further include, before determining, by the first device, whether or not the a security code of the second device has been registered: generating a list of registered devices which are available for communication using the millimeter wave band, including the second device among one or more ambient devices included within an RFID communication distance; and displaying the generated list of the registered devices.

The generating of the list of the registered devices may include: requesting, by the first device, device IDs of the respective ambient devices and communication mode information indicating whether or not each of the devices is available for millimeter wave band communication from the one or more ambient devices included within the RFID communication distance through RFID communication; determining, by the first device, whether or not there is a device available for millimeter wave band communication on the basis of the device IDs and the communication mode information transmitted from the one or more ambient devices included within the RFID communication distance through RFID communication; and when there is at least one device available for millimeter wave band communication, updating, by the first device, the list of the registered devices.

The updating of the list of the registered devices may include: determining, by the first device, whether or not each of one or more devices available for millimeter wave band communication has been registered based on a device ID of each of one or more devices available for millimeter wave band communication; and storing a device, which has not been registered, among the one or more devices available for millimeter wave band communication, in the list of the registered devices.

The transmitting of an activation command instructing the second device to perform millimeter wave band communication, a device ID, and the security code of the second device by the first device to the second device through RFID communication when the first device determines that the security code of the second device has been registered may include: when the first device determines that the security code of the second device has not been registered, displaying, by the first device, a user interface for receiving the security code from a user.

The method may further include, after transmitting, by the first device, an activation command instructing the second device to perform millimeter wave band communication, a device ID, and the security code of the second device to the second device through RFID communication: comparing, by the second device, the security code transmitted from the first device and a stored security code to determine whether or not both security codes are identical; and when the security code transmitted from the first device and the stored security code are not identical, requesting, by the second device, a retransmission of the security code from the first device through RFID communication.

The requesting, by the second device, of a retransmission of the security code from the first device through RFID communication, when the security code transmitted from the first device and the stored security code are not identical, may include: when the security code transmitted from the first device and the stored security code are identical, activating, by the second device, an element for performing communication using a milliliter wave band; and transmitting, by the second device, a message indicating that the second device is ready for millimeter wave band communication to the first device.

According to another aspect of the present invention, there is provided a device using a millimeter wave band, including: a millimeter wave communication unit activated according to an activation control signal and performing data transmission and reception by using a millimeter wave band; an RFID communication unit performing pairing with a particular device selected according to a pairing control signal; and a controller providing the pairing control signal to the RFID communication unit and providing the activation control signal to the millimeter wave communication unit after the pairing with the particular device is completed in order to thus provide control to perform data transmission and reception by using the millimeter wave band with the particular device.

The RFID communication unit may include: an RFID reader activated under the control of the controller to generate a list of registered devices and provide a pairing request signal to the selected particular device; and an RFID tag transmitting a device ID and communication mode information indicating whether or not millimeter wave band communication is available according to a request for information of a certain device.

The RFID reader may be activated under the control of the controller to request a device ID of each of ambient devices and communication mode information from one or more ambient devices included within RFID communication distance, and generate a list of the registered devices which are available for millimeter wave band communication based on the device IDs and communication mode information provided from one or more ambient devices included within the RFID communication distance.

The device may further include: a storage unit storing the list of the registered devices; an input/output unit displaying the list of the registered devices under the control of the controller, and providing information regarding a device selected by a user from the displayed list of the registered devices to the controller.

When a pairing control signal indicating pairing with the selected particular device is provided from the controller, the RFID reader may determine whether or not a security code of the selected particular device has been registered, and when the security code of the selected particular device has been registered, the RFID reader may transmit an activation command instructing an activation of the millimeter wave communication unit of the selected particular device, the device ID, and the security code of the selected particular device.

When it is determined that the security code of the selected particular device has not been registered, the RFID reader may provide an event signal for receiving the security code of the selected particular device from the user to the controller, and the controller may provide control to display a user interface to receive the security code of the selected particular device according to the event signal.

When the security code is received from the certain device and the received security code is identical to a previously stored security code, the RFID tag may provide a signal indicating an activation of the millimeter wave communication unit to the controller, and the controller may activate the millimeter wave communication unit according to the signal indicating the activation of the millimeter wave communication unit provided from the RFID tag.

When a message indicating that the certain device is ready for millimeter wave band communication, the RFID tag may provide a signal indicating an activation of the millimeter wave communication unit to the controller, and the controller may activate the millimeter wave communication unit according to the signal indicating the activation of the millimeter wave communication unit provided from the RFID tag.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view for explaining a pairing of devices using a millimeter wave band according to an exemplary embodiment of the present invention;

FIG. 2 is a schematic block diagram of a device using the millimeter wave band according to an exemplary embodiment of the present invention;

FIG. 3 is a schematic block diagram of a device using a millimeter wave band according to another exemplary embodiment of the present invention;

FIG. 4 is a flow chart illustrating the process of creating a list of ambient devices of a device using a millimeter wave band according to another exemplary embodiment of the present invention; and

FIG. 5 is a flow chart illustrating a pairing process of the device using the millimeter wave band according to another exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

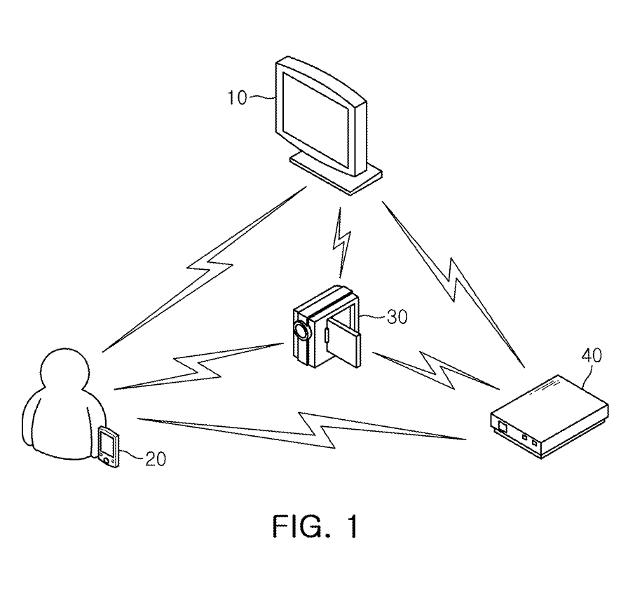

FIG. 1 is a conceptual view for explaining a pairing of devices using a millimeter wave band according to an exemplary embodiment of the present invention, illustrating a case in which devices at home perform pairing therebetween and transmit and receive data by using a 60 GHz band.

With reference to FIG. 1, communication using the 60 GHz band is available for ultra-high wireless transmission, allowing a display device 10, a mobile terminal 20, a camcorder 30, and a large capacity storage device 40 located at home to be wirelessly connected and transmit or receive HD image data, high quality audio or large capacity data therebetween.

For example, the camcorder 30 may transmit HD image data stored therein to the display device 10 through radio communication using the 60 GHz band, whereby a recorded image can be reproduced conveniently without having to connect the two devices 10 and 30 through a data cable. Also, the mobile terminal 20 and the large capacity storage device 40 may transmit and receive large capacity data through radio communication using the 60 GHz band.

In order to perform radio communication between the devices, the display device 10, the mobile terminal 20, the camcorder 30, and the large capacity storage device 40 include a 60 GHz communication unit for performing communication by using the 60 GHz band and an RFID communication unit acquiring information regarding whether or not there is an ambient device and communication mode information indicating whether or not 60 GHz communication is available, and performing pairing with the corresponding device, respectively.

For example, the pairing process between the mobile terminal 20 and the large capacity storage device 40, among the devices illustrated in FIG. 1, will now be described. When an event indicating pairing is provided from a user, the mobile terminal 20 reads RFID tags from devices present around the mobile terminal 20 (e.g., within 10 meters) to determine whether or not there are ambient devices, whether or not the ambient devices are available for communication using 60 GHz band, security information, and the like, and registers the same.

Thereafter, when the user instructs communication using the 60 GHz band with the large capacity storage device 40 among the devices registered through the mobile terminal 20, the mobile terminal 20 transmits a wakeup command, a unique device ID, and a security code to an RFID tag of the large capacity storage device 40. Then, the large capacity storage device 40 compares the received security code and its security code, and when the two security codes are identical, the large capacity storage device 40 wakes up the 60 GHz communication unit and transmits and receives data to and from the mobile terminal 20 by using the 60 GHz band.

As described above, in the pairing method of the device using the millimeter band according to an exemplary embodiment of the present invention, pairing between the respective devices is performed by using RFID communication, and an element (namely, the 60 GHz communication unit) performing communication by using the 60 GHz band is activated (or wakes up) only when it performs data communication, and when the 60 GHz communication unit does not perform communication, it is in a sleep state. Thus, power consumption can be remarkably reduced when compared with the related art devices which are periodically activated in response to a pairing request.

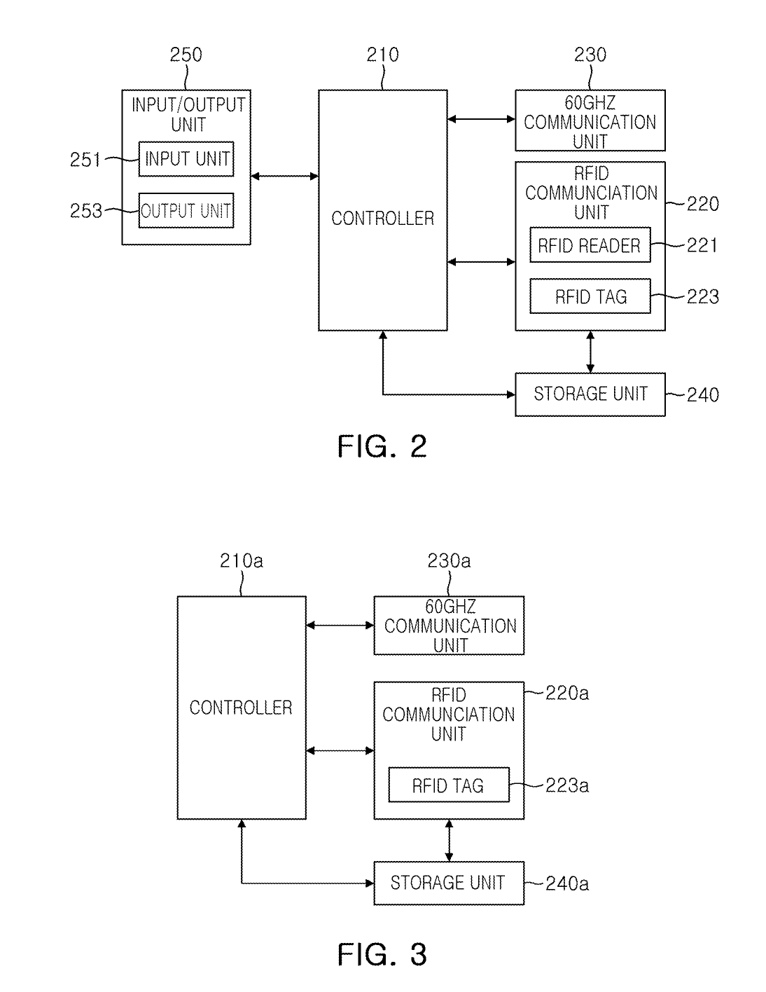

FIG. 2 is a schematic block diagram of a device using the millimeter wave band according to an exemplary embodiment of the present invention.

With reference to FIG. 2, a device using a millimeter wave band (referred to as a ‘millimeter wave band using device’, hereinafter) according to an exemplary embodiment of the present invention includes a controller 210, an RFID communication unit 220, a 60 GHz communication unit 230, a storage unit 240, and an input/output unit 250.

The controller 210 controls the RFID communication unit 220 and the 60 GHz communication unit 230 to register an ambient device and perform pairing in order to perform communication using a 60 GHz band.

In detail, the controller 210 may activate the RFID reader 221 according to an ambient device registration request from the user and determine whether or not there is an ambient device based on the ambient device information provided from the RFID reader 221, the controller 210 displays that there is no ambient device available for communication through the input/output unit 250.

Also, when a pairing request is provided from the user through the input/output unit 250, the controller 210 controls the RFID reader 221 to receive a list of registered devices from the RFID reader 221 and displays the received list of registered devices through the input/output unit 250. When the user selects a particular device from the displayed list of registered devices, the controller 210 controls the RFID communication unit 220 to perform pairing with the particular device.

Also, when an event signal requesting a security code is provided from the RFID reader in the process of performing pairing with the particular device, the controller 210 displays a user interface for receiving a security code from the user through the input/output unit 250, and provides a security code input by the user through the input/output unit 250 to the RFID reader 221.

When the pairing with the particular device through the RFID communication unit 220 is completed, the controller 210 activates the 60 GHz communication unit 230 to perform data communication using the 60 GHz band with the particular device.

In detail, when a signal indicating an activation of the 60 GHz communication unit 230 is provided from the RFID tag 223, the controller 210 activates the 60 GHz communication unit 230, connects a different element included in the millimeter wave band using device to the 60 GHz communication unit 230 and provides control to perform communication. At the time that the signal indicating the activation of the 60 GHz communication unit 230 is provided, the controller 210 may also activate the 60 GHz communication unit 230, receive data from a different element included in the millimeter wave band using device, deliver the received data to the 60 GHz communication unit 230 or deliver it to a corresponding element included in the millimeter wave band using device, thus performing communication using the 60 GHz band with the different device.

The RFID communication unit 220 may include an RFID reader 221 and an RFID tag 223. The RFID reader 221 and the RFID tag 223 may be activated or deactivated under the control of the controller 210. For example, the RFID reader 221 and the RFID tag 223 may be activated under the control of the controller 210 only when pairing is performed with a different device available for communication by using the 60 GHz band.

The RFID reader 221 is activated under the control of the controller 210 to read an RFID tag installed in an ambient device and provide the read ambient device information to the controller 210.

Or, the RFID reader 221 may be periodically activated at pre-set time intervals to read the RFID tags of ambient devices and store a list of registered devices based on the read content in the storage unit 240. If reading the RFID tags of the ambient devices, an ambient device having no reaction is excluded from the stored list of registered devices and an ambient device corresponding to the newly read RFID tag is stored in the list of the registered devices, thus periodically updating the list of the registered devices.

Also, the RFID reader 221 requests a device ID and communication mode information from each ambient device and deletes an ambient device not available for communication using the 60 GHz band from the list of the registered devices on the basis of the communication mode information transmitted from the RFID tag of each ambient device. When an ambient device is available for communication using the 60 GHz band, the RFID reader 221 determines whether or not a security code of the ambient device has been registered based on the device ID transmitted from the corresponding device. Here, when the security code of the ambient device has been registered, it can communicate using the 60 GHz band according to a communication request from the user without performing a security code input procedure. The communication mode information refers to whether or not communication using the 60 GHz band is available. The user of each device may set the communication mode, and although a device supports communication using the 60 GHz band, if the user has set a device to not use communication using 60 GHz band, communication using the 60 GHz band cannot be performed.

Also, the RFID reader 221 provides the stored list of registered devices to the controller 210 under the control of the controller 210, and when a request for pairing with a particular device is provided from the controller 210, the RFID reader 221 checks whether or not the security code of the particular device has been registered. When the security code of the particular device has been registered, the RFID reader 221 transmits an activation command, a device ID, and the security code to the RFID tag of the particular device. In the case that the security code has not been registered, the RFID reader 221 provides an event signal for acquiring the security code from the user to the controller 210. Then, the controller 210 displays a user interface for receiving a security code on the input/output unit 250 according to the event signal provided from the RFID reader 221, acquires a security code provided through the input/output unit 250 by the user, and provides the acquired security code to the RFID reader 221.

When the RFID tag 223 receives an information request transmitted from an RFID reader of an ambient device, it transmits a device ID and communication mode information to the RFID reader of the ambient device.

Also, when a security code is transmitted from an RFID reader of a different device, the RFID tag 223 receives it and compares the received security code with its security code stored in the storage unit 240. When the two security codes are identical, the RFID tag 223 provides a signal for activating the 60 GHz communication unit 230 to the controller 210. When the two security codes are not identical, the RFID tag 223 provides an event signal indicating a re-transmission of the security code to the RFID reader 221 or the controller 210. When the security code re-transmitted from the different device is still not identical, the RFID tag 223 provides an event signal for acquiring a security code from the user to the controller 210.

When a communication preparation completion message using the 60 GHz band is received from a particular device performing pairing, the RFID tag 223 provides an activation signal indicating an activation of the 60 GHz communication unit 230 to the controller 210.

The 60 GHz communication unit 230 is activated (wakes up) or deactivated (sleeps) under the control of the controller 210, and performs high speed data communication by using the 60 GHZ frequency band. Here, after completing pairing with a communication counterpart device, the 60 GHz communication unit 230 is activated under the control of the controller 210 only when it substantially performs communication by using the 60 GHz band, and deactivated when it does not perform communication, thereby preventing unnecessary power consumption.

The storage unit 240 may be configured as a non-volatile memory storing a device ID, a communication mode, a security code. Also, the storage unit 240 stores the list of registered devices provided by the RFID reader 221.

The input/output unit 250 may include an input unit 251 having a plurality of keypads and an output unit 253 configured as a liquid crystal display (LCD) or an organic light emitting diode (OLED). The input unit 251 and the output unit 253 may be implemented in the form of a single touch screen or a touch pad.

The input/output unit 250 displays a user interface for receiving the list of the registered devices or the security code under the control of the controller 210, and provides a key event signal corresponding to a key manipulated by the user to the controller 210.

The millimeter wave band using device illustrated in FIG. 2 may be installed in the device having various forms as shown in FIG. 1, and in this case, various other elements than those illustrated in FIG. 1 may be further included. For example, when the millimeter wave band using device illustrated in FIG. 2 is installed in the display device 10 illustrated in FIG. 1, elements such as a tuner, an image processing unit, a large display element, and the like, for performing a unique function of the display device 10 may be further included in addition to the elements illustrated in FIG. 2.

FIG. 3 is a schematic block diagram of a device using a millimeter wave band according to another exemplary embodiment of the present invention.

The device using a millimeter wave band according to another exemplary embodiment of the present invention is configured not to include the input/output unit and the RFID reader of the millimeter wave band using device illustrated in FIG. 2.

Namely, the device using a millimeter wave band according to an exemplary embodiment of the present invention illustrated in FIG. 2 may request pairing from a different ambient device or respond to a request for pairing from the different device, but the device using a millimeter wave band according to another exemplary embodiment of the present invention illustrated in FIG. 3 cannot perform a request for pairing from a different device and can only respond to a request for pairing from a different device.

With reference to FIG. 3, the device using a millimeter wave band according to another exemplary embodiment of the present invention includes a controller 210a, an RFID communication unit 220a, a 60 GHz communication unit 230a, and a storage unit 240a.

In order to perform communication using the 60 GHz band, the controller 210a controls the RFID communication unit 220a and the 60 GHz communication unit 230a.

In detail, when a signal indicating an activation of the 60 GHz communication unit 230a is provided from the RFID tag 223a, the controller 210a activates the 60 GHz communication unit 230a, connects a different element included in the millimeter wave band using device to the 60 GHz communication unit 230a and provides control to perform communication. Or, when the signal indicating the activation of the 60 GHz communication unit 230a is provided, the controller 210a may activate the 60 GHz communication unit 230a, receive data from a different element included in the millimeter wave band using device, deliver the received data to the 60 GHz communication unit 230a or deliver it to a corresponding element included in the millimeter wave band using device, thus performing communication using the 60 GHz band with the different device.

The RFID communication unit 220a may include an RFID tag 223a. When an information request transmitted from an RFID reader of an ambient device is received, the RFID tag 223a transmits a device ID and communication mode information to the RFID reader of the ambient device. Here, the communication mode refers to whether or not communication using the 60 GHz band is available. The user of each device may set the communication mode, and although a device supports communication using the 60 GHz band, if the user has set a device to not use communication using the 60 GHz band, communication using the 60 GHz band cannot be performed.

Also, when a security code is transmitted from an RFID reader of a different device, the RFID tag 223a receives it and compares the received security code with its security code stored in the storage unit 240a. When the two security codes are identical, the RFID tag 223a provides a signal for activating the 60 GHz communication unit 230a to the controller 210a. When the two security codes are not identical, the RFID tag 223a transmits an event signal indicating a re-transmission of the security code to the RFID reader of the different device. When a communication preparation completion message using the 60 GHz band is received from a particular device performing pairing, the RFID tag 223a provides an activation signal indicating an activation of the 60 GHz communication unit 230a to the controller 210a.

The 60 GHz communication unit 230a is activated (wakes up) or deactivated (sleeps) under the control of the controller 210a, and performs high speed data communication by using the 60 GHZ frequency band. Here, after completing pairing with a communication counterpart device, the 60 GHz communication unit 230a is activated under the control of the controller 210a only when it substantially performs communication by using the 60 GHz band, and deactivated when it does not perform communication, thereby preventing unnecessary power consumption.

The storage unit 240a may be configured as a non-volatile memory storing a device ID, a communication mode, a security code.

The millimeter wave band using device illustrated in FIG. 3 may be implemented in the form of a device that does not require an input/output unit such as the large capacity storage device 40 illustrated in FIG. 1.

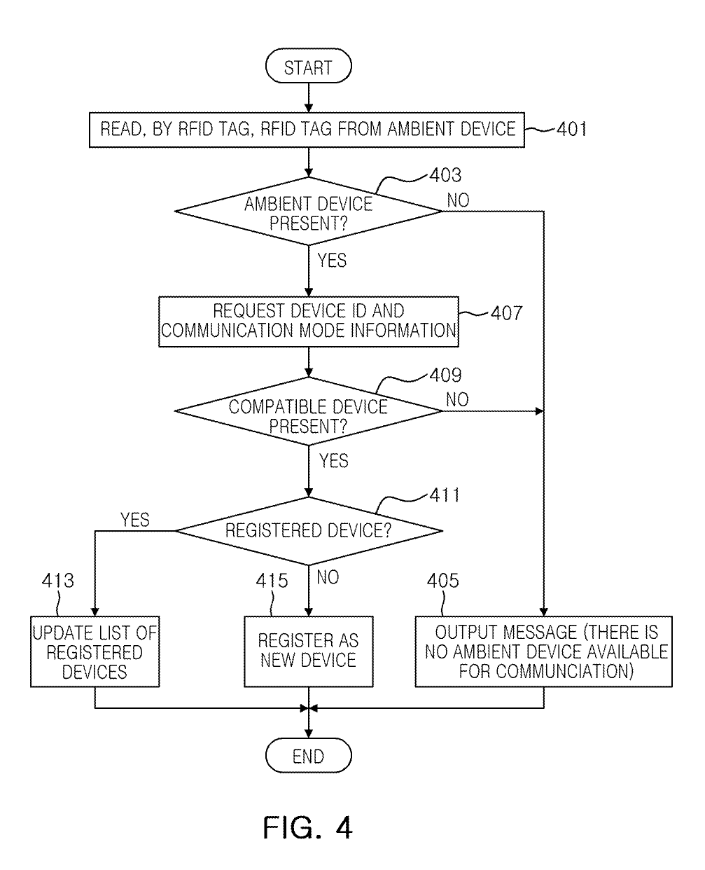

FIG. 4 is a flow chart illustrating the process of creating a list of ambient devices of a device using a millimeter wave band according to another exemplary embodiment of the present invention, specifically, illustrating the process of creating a list of ambient devices performed by a millimeter wave band using device including an RFID reader and an RFID tag.

With reference to FIG. 4, first, the millimeter wave band using device applies power to the RFID reader to activate the RFID reader, and the activated RFID reader reads an RFID tag included in each of devices located nearby to search for ambient devices (step 401).

Next, the millimeter wave band using device determines whether or not there is an ambient device based on the results of reading the RFID tags (step S403). When the millimeter wave band using device determines that there is no ambient device, it outputs a message indicating that there is no ambient device available for communication (step 405) and terminates the ambient device list creating process.

Meanwhile, when the millimeter wave band using device determines that there is at least one ambient device in step 403, the RFID reader of the millimeter wave band using device requests a device ID and communication mode information from the RFID tag of each of the detected devices (step 407). Here, the communication mode information refers to whether or not communication using the 60 GHz band is available. The user of each device may set the communication mode, and although a device supports communication using the 60 GHz band, if the user has set a device to not use communication using the 60 GHz band, communication using the 60 GHz band cannot be performed.

The millimeter wave band using device determines whether or not there is a compatible device which is available for communication and uses the 60 GHz band on the basis of the device IDs and communication mode information acquired from the respective ambient devices through the RFID reader (step 409). When the millimeter wave band using device determines that there is no compatible device, the millimeter wave band using device outputs a message indicating that there is no ambient device available for communication (step 405) and terminates the ambient device list creating process.

Meanwhile, when the millimeter wave band using device determines that there is at least one compatible device using the 60 GHz band, the millimeter wave band using device compares the device ID acquired the compatible device with a stored device ID list to determine whether or not the compatible device is a registered device (step 411). When the compatible device is determined to be a registered device, the millimeter wave band using device stores it in the list of registered devices to thus update the list of registered devices (step 413). When the compatible device is not a registered device, the millimeter wave band using device registers the compatible device as a new device (step 415) and terminates the ambient device registration process.

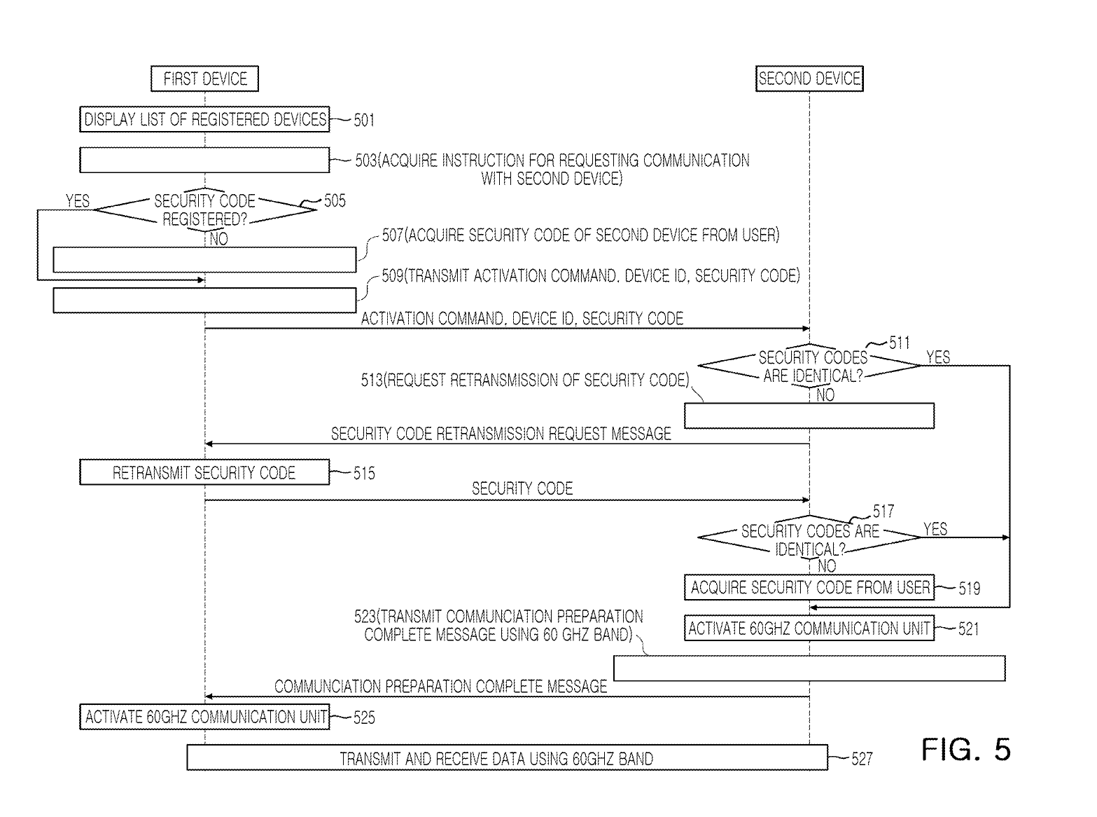

FIG. 5 is a flow chart illustrating a pairing process of the device using the millimeter wave band according to another exemplary embodiment of the present invention. In FIG. 5, it is illustrated that after the ambient device registration process as illustrated in FIG. 4 is performed, pairing is intended to communicate with a second device by using the 60 GHz band, and the second device performs pairing in response thereto.

With reference to FIG. 5, first, a first device displays a list of registered devices of ambient devices which have been registered in response to a user request (step 501). The user selects a second device from the displayed list of registered devices, and when the user requests pairing with the selected second device, the first device acquires information according to the user selection and indication (namely, the second device and pairing request information) (step 503).

For example, when the first device is the mobile terminal 20 illustrated in FIG. 1 and the list of registered devices includes the display device 10, the camcorder 30, and the large capacity storage device 40 illustrated in FIG. 1, the mobile terminal 20 displays the information regarding the display device 10, the camcorder 30, and the large capacity storage device 40 as registered on the display unit in step 501, and when the user selects the display device 10 as a second device in step 503, pairing is performed with the selected display device 10.

Next, the first device determines whether or not a security code of the second device has been registered (step 505). Here, when there is communication history between the first and second devices, the security code of the second device has been registered to the first device, so a security code input process is not required. Meanwhile, when the first and second devices communicate with each other for the first time, the security code of the second device must be received from the user for pairing.

Thus, when the security code of the second device has not been registered in step 505, the first device displays a user interface for receiving the security code of the second device and acquires the security code of the second device inputted by the user (step 507).

And then, the first device transmits an activation (wakeup) command indicating an activation of the 60 GHz communication unit of the second device, a device ID, the security code to the second device through an RFID reader (step 509).

Meanwhile, when the security code of the second device is determined to have been registered in step 505, the first device directly performs step 509, skipping step S507.

The RFID tag of the second device receives the activation command, the device ID and the security code transmitted from the first device, compares the received security code with a previously stored security code to determine whether or not the two codes are identical (step 511). When the security codes are not identical, the second device requests re-transmission of the security code from the first device through the RFID tag (step 513).

When the re-transmission of the security code is requested from the second device, the first device re-transmits the security code through the RFID reader or the RFID tag (step 515), and the RFID tag of the second device determines whether or not the security code re-transmitted from the first device is identical (step 517). When the re-transmitted security code is not identical, the second device displays a user interface for receiving a security code from the user and acquires a security code input by the user (step 519).

Meanwhile, when the security code is identical in step 511 or 517, power is applied to the 60 GHz communication unit handling communication of the 60 GHz band of the second device to activate the 60 GHz communication unit (step 521) and informs the first device that communication using the 60 GHz band is ready (step 523).

Upon being informed that the second device is ready for communication using the 60 GHz band, the first device activates the 60 GHz communication unit (step 525) and transmits and receives data to and from the second device by using the 60 GHz band (step 527).

As set forth above, in the pairing method using a millimeter wave band and a device performing the method according to exemplary embodiments of the invention, an RFID communication unit is periodically activated to acquire a device ID and communication mode information of a device existing nearby, and generate and manage a list of registered devices based on the acquired information. When a request for pairing with a particular device is provided from the user, the RFID communication unit transmits an activation command instructing an activation of a 60 GHz communication unit, a device ID, and a security code to the particular device to request pairing. Thereafter, when a message indicating that communication using a 60 GHz band is ready is transmitted from the particular device, the 60 GHz communication unit performing communication of the 60 GHz band is activated and data is transmitted and received by using the 60 GHz band.

Thus, pairing is performed by using RFID communication, and an element (namely, the 60 GHz communication unit) performing communication by using the 60 GHz band is activated only when it performs high speed data communication and not activated (in a sleep state) when it does not perform communication, thereby conveniently performing pairing. In addition, because power consumption is considerably reduced compared with the related art devices which are periodically activated to respond to a pairing request, the mobile terminal that performs communication by using the 60 GHz band can have a lengthened usage time.

While the present invention has been shown and described in connection with the exemplary embodiments, it will be apparent to those skilled in the art that modifications and variations can be made without departing from the spirit and scope of the invention as defined by the appended claims.

What is claimed is:

1. A pairing method of first and second devices each having a communication function using a millimeter wave band, the method comprising:
determining, by the first device, whether or not the a security code of the second device, which a pairing is requested with, has been registered;
when the first device determines that the security code of the second device has been registered, transmitting, by the first device, an activation command instructing the second device to perform millimeter wave band communication, a device ID, and the security code of the second device to the second device through RFID communication; and
when the first device receives a message indicating that the second device is ready for millimeter wave band communication from the second device, activating, by the first device, an element for performing communication using the millimeter wave band.

2. The method of claim 1, further comprising,
before determining, by the first device, whether or not the a security code of the second device has been registered:
generating a list of registered devices which are available for communication using the millimeter wave band, including the second device among one or more ambient devices included within an RFID communication distance; and
displaying the generated list of the registered devices.

3. The method of claim 2, wherein the generating of the list of the registered devices comprises:
requesting, by the first device, device IDs of the respective ambient devices and communication mode information indicating whether or not each of the devices are available for millimeter wave band communication from the one or more ambient devices included within the RFID communication distance through RFID communication;
determining, by the first device, whether or not there is a device available for millimeter wave band communication on the basis of the device IDs and the communication mode information transmitted from the one or more ambient devices included within the RFID communication distance through RFID communication; and
when there is at least one device available for millimeter wave band communication, updating, by the first device, the list of the registered devices.

4. The method of claim 3, wherein the updating of the list of the registered devices comprises:
determining, by the first device, whether or not each of one or more devices available for millimeter wave band communication has been registered based on a device ID of each of one or more devices available for millimeter wave band communication; and
storing a device, which has not been registered, among the one or more devices available for millimeter wave band communication, in the list of the registered devices.

5. The method of claim 1, wherein the transmitting of an activation command instructing the second device to perform millimeter wave band communication, a device ID, and the security code of the second device by the first device to the second device through RFID communication when the first device determines that the security code of the second device has been registered, comprises:
when the first device determines that the security code of the second device has not been registered, displaying, by the first device, a user interface for receiving the security code from a user.

6. The method of claim 1, further comprising,
after transmitting, by the first device, an activation command instructing the second device to perform millimeter wave band communication, a device ID, and the security code of the second device to the second device through RFID communication:
comparing, by the second device, the security code transmitted from the first device and a stored security code to determine whether or not both security codes are identical; and
when the security code transmitted from the first device and the stored security code are not identical, requesting, by the second device, a retransmission of the security code from the first device through RFID communication.

7. The method of claim 6, wherein the requesting, by the second device, of a retransmission of the security code from the first device through RFID communication, when the security code transmitted from the first device and the stored security code are not identical, comprises:
when the security code transmitted from the first device and the stored security code are identical, activating, by the second device, an element for performing communication using a milliliter wave band; and
transmitting, by the second device, a message indicating that the second device is ready for millimeter wave band communication to the first device.

8. A device using a millimeter wave band, the device comprising:
a millimeter wave communication unit activated according to an activation control signal and performing data transmission and reception by using a millimeter wave band;
an RFID communication unit performing pairing with a particular device selected according to a pairing control signal; and
a controller providing the pairing control signal to the RFID communication unit and providing the activation control signal to the millimeter wave communication unit after the pairing with the particular device is completed in order to thus provide control to perform data transmission and reception by using the millimeter wave band with the particular device.

9. The device of claim 8, wherein the RFID communication unit comprises:
an RFID reader activated under the control of the controller to generate a list of registered devices and provide a pairing request signal to the selected particular device; and
an RFID tag transmitting a device ID and communication mode information indicating whether or not millimeter wave band communication is available according to a request for information of a certain device.

10. The device of claim 9, wherein the RFID reader is activated under the control of the controller to request a device ID of each of ambient devices and communication mode information from one or more ambient devices included within RFID communication distance, and generates a list of the registered devices which are available for millimeter wave band communication based on the device IDs and communication mode information provided from one or more ambient devices included within the RFID communication distance.

11. The device of claim 9, further comprising:
a storage unit storing the list of the registered devices;
an input/output unit displaying the list of the registered devices under the control of the controller, and providing information regarding a device selected by a user from the displayed list of the registered devices to the controller.

12. The device of claim 9, wherein when a pairing control signal indicating pairing with the selected particular device is provided from the controller, the RFID reader determines whether or not a security code of the selected particular device has been registered, and when the security code of the selected particular device has been registered, the RFID reader transmits an activation command instructing an activation of the millimeter wave communication unit of the selected particular device, the device ID, and the security code of the selected particular device.

13. The device of claim 12, wherein when it is determined that the security code of the selected particular device has not been registered, the RFID reader provides an event signal for receiving the security code of the selected particular device from the user to the controller, and the controller provides control to display a user interface to receive the security code of the selected particular device according to the event signal.

14. The device of claim 9, wherein when the security code is received from the certain device and the received security code is identical to a previously stored security code, the RFID tag provides a signal indicating an activation of the millimeter wave communication unit to the controller, and the controller activates the millimeter wave communication unit according to the signal indicating the activation of the millimeter wave communication unit provided from the RFID tag.

15. The device of claim 9, wherein when a message indicating that the certain device is ready for millimeter wave band communication, the RFID tag provides a signal indicating an activation of the millimeter wave communication unit to the controller, and the controller activates the millimeter wave communication unit according to the signal indicating the activation of the millimeter wave communication unit provided from the RFID tag.
